(19) United States
(12) Patent Application Publication
(10) Pub. No.: US 2011/0040647 A1
(43) Pub. Date: Feb. 17, 2011

(54) FRAUD PREVENTION TRADING AND PAYMENT SYSTEM FOR BUSINESS AND CONSUMER

(76) Inventors: Gabriel Johann Petrovici, Köln (Cologne) (DE); Michelle Anna Rollar, Köln (Cologne) (DE)

Correspondence Address: Gabriel Johann Petrovici, Durener Str. 404, Köln (Cologne), 50935, DE

(21) Appl. No.: 12/846,844

(22) Filed: Jul. 30, 2010

Related U.S. Application Data
(60) Provisional application No. 61/229,992, filed on Jul. 30, 2009.

(51) Int. Cl. G06Q 30/00; G06Q 20/00

(52) U.S. Cl. 705/26.3

(57) ABSTRACT

A code system for preventing fraud in trading and at the same time a safe payment method for business and consumer. The code system of the present invention ensures security and control for the contracting parties regarding the previously defined attributes of the goods and the payment including all decisional steps of the transactions as well as of the reverse transactions in case of complaint.

The contracting parties act complementary, money and goods or money and services are never at the same time under control of one contracting party.

### PRIORITY

The present application claims priority to a U.S. Provisional Patent Application entitled Time- and placerelated trade- and interestslinking search- and auctionsystem on the internet (world wide web) filed Jul. 30, 2009, Application No. 61/229,992, the contents of which are incorporated herein by reference.

### FIELD OF INVENTION

Our invention, the “fraud prevention trading and payment system for business and consumer” makes it possible to handle a contract between two or more contracting parties from the beginning to the conclusion of the contract including the safe handling of payments.

The present invention is directed to business to business, abbreviated as B2B, to consumer to consumer, abbreviated as C2C and to business to consumer, abbreviated as B2C.

### BACKGROUND OF INVENTION

At the time being there exist business to business internet platforms and consumer to consumer internet platforms as well as business to consumer platforms. Many of the B2B internet platforms establish contacts between the businesses, the transaction does not necessarily take place on the internet platform, that offers the possibility to contact other businesses. Other B2B, C2B and C2C internet platforms have the possibility of closing a deal and paying on the same internet platform. Different payment systems can be used, here is a brief overview:

In import/export letter of credit is a frequently used method of payment. The advantage is a high security standard, on the other hand there are high costs for the banks services for the contracting parties because of the high bureaucracy and usually quite a long duration of the whole settlement.

An other payment situation is represented by payment on account, in this case bank wire transfer or direct debit, also by online banking are frequently used payment methods in the domestic and also in the international market. Other payment possibilities are represented by creditcard, debitcard, e-wallet payment methods, any prepaid payment methods and moneytransfer with immediate cash payout systems. The buying party is clearly in advantage compared to the vendor, because it receives first the goods or services, can verify the quality and pay afterwards. The vendor party takes the risk of cash loss in case of fraud or insolvency.

Cash on delivery is a special case, because it does not give the buyer the possibility to verify the content and the quality of the goods he receives, since he has to pay on the spot even before opening the package.

One more payment situation is the payment in advance, in which all the payment systems that are also used for payment on account, like above mentioned, can be used. Clearly the advantage is in the case of payment in advance on the vendors side, the buyer has the risk of cash loss in case of fraud or the risk that the goods or services he buys are not corresponding to the description given by the vendor.

All the above payment methods have in common that they can guarantee secure payment. Except for the letter of credit none of the above mentioned payment systems is able to prevent fraud for both contracting parties or to solve the problem of insolvency. As far as the letter of credit is concerned, the control during the transaction is entirely in the hands of the banks of the two or more contracting parties, if any objection regarding the quality of the contracted goods occurs, there is no possibility for the contracting parties to take any action. The inventors have developed the present invention which overcomes the drawbacks of the existing payment systems, the “fraud prevention trading and payment system for business and consumer” solves all these problems. By using our invention none of the contracting parties has at the same time control over money and goods or over money and services. These embodiments, and others described in greater detail herein, give the contracting parties the possibility of following and control a contract step by step until the conclusion and pay-out in absolute security in every decisional situation without becoming a victim of fraud, insolvency or similar inconvenient cases. Other features and advantages of the present invention will become apparent to those skilled in the art from the following detailed description.

### SUMMARY OF THE INVENTION

There is no use for a vendor, if the buyer is a defrauder or insolvent and there is no use for the buyer, if he payed already the vendor, but the goods or services he payed for do not correspond to the description of the contracted goods or services. This is why the invention of the “fraud prevention trading and payment system for business and consumer” is useful for everybody who wants to sell or buy goods or services. It is a non bureaucratic system, that allows security and control for the contracting parties over the quality of the goods and the payment by freezing the complete purchase price on the buyers account and a deposit on the vendors account. The contracting parties keep control over every decisional step of the transaction. In case of complaint reverse transactions are possible.

### DETAILED DESCRIPTION OF THE PREFERRED EMBODIMENT

In the preferred embodiment the invention is implemented on a computer or electronic terminal. The system is able to interact with the bank and the contracting parties (two or more). All contracting parties have their account at the same e-wallet firm or a bank account at the same bank and a trading platform is combined with that very bank or e-wallet firm It is envisioned that the system of the present invention can be implemented on any existing or future terminal or device with the processing capability to perform the functions described herein. The scope of the present invention is not limited by the type of terminal or device used. Further, the specification refers to a single click of a mouse as a means for user input and interaction with the terminal display as an example of a single action of the user. While this describes a preferred mode of interaction, the scope of the present invention is not limited to the use of a mouse as the input device or to the click of a mouse button as the users single action. Rather any action by a user regarding one transaction (code/deal), whether comprising one or more clicks of a mouse button, the input of a code or other input device, is considered a single action of the user for the purposes of the present invention. The system can be applied to two or more (three, four, five, six, seven and many more matching codes). Only when the specific transaction is confirmed by the designated number of persons by input of components of the code or by mouse clicks, the transaction is completed.

It should be understood that the above description of the invention and specific examples, while indicating preferred embodiments of the present invention, are given by way of illustration and not limitation. Many changes and modifications within the scope of the present invention may be made without departing from the spirit thereof, and the present invention includes all such changes and modifications.

COMPUTER LISTING OF THE INVENTION

```
// charges, advanced auction description, shipping selection and
// direct pay option omitted due to missing logical relevance
// frozen money gets automatically paid out to the (new) owner when
// the seller and the buyer go along with eachother or when someone
// times out, that could be also executed by some action of the
// (new) owner
BidPercentage = 1.0;
if(Page == “AuctionInsertion”)
{
        if(CurrentUser != Guest)
        {
              Inserted = false;
              if(WasButtonPressed(“Insert”))
              {
                      if(AtleastAllMandantoryFieldsFilledOut)
                      {
                            // Input.Duration means the number of days until
                            // auction times out
                            // Input.FreezePercentage lets the seller specify
                            // how much he wants to freeze: lets him appear
                            // trustworthy
                            ToBeFreezed = (Input.StartPrice/100.0)*
                                    Input.FreezePercentage;
                            if(CurrentUser.Money >= ToBeFreezed)
                            {
                                    // Create new auction
                                    Auction = new Auction;
                                    Auction.Mode = “AuctionRunning”;
                                    Auction.Seller = CurrentUser;
                                    Auction.Seller.Money −= ToBeFreezed;
                                    Auction.SellerFrozen = ToBeFreezed;
                                    Auction.StartPrice = Input.StartPrice;
                                    Auction.StartTime = TimeStamp( );
                                    Auction.Duration = Input.Duration;
                                    Inserted = true;
                                    // if we want a pair of codes (generating them
                                    // just before they can be used proposed)
                                    Auction.SellerCode = GenerateCode( );
                                    Auction.BuyerCode = GenerateCode( );
                            }
                      }
              }
              if(!Inserted)
              {
                      // StartPrice has to be minimum 1
                      ShowNumberInput(“StartPrice”);
                      // FreezePercentage has to be minimum 1 and maximum 100
                      ShowNumberInput(“FreezePercentage”);
                      // Duration has to be minimum 1
                      ShowNumberInput(“Duration”);
              }
        }
}
else if(Page == “SingleAuctionOverview”)
{
        if(Auction.Mode == “Auction Running”)
        {
              if(WasButtonPressed(“Bid”) &&
                      (CurrentUser != Guest && CurrentUser != Auction.Seller))
              {
                      if(AtleastAllMandantoryFieldsFilledOut)
                      {
                            // Auction.Buyer is the one with the best bid
                            // as long as there is at least one bid
                            // CurrentPrice is the best bid amount if there
                            // is one otherwise just check against StartPrice
                            // Whether the bid amount is high enough
                            if((!Auction.Buyer &&
                                    Input.BuyPrice > Auction.StartPrice)
                                    || Input.BuyPrice > Auction.CurrentPrice)
                            {
                                    ToBeFreezed = (Input.BuyPrice/100.0)*
                                          BidPercentage;
                                    if(CurrentUser.Money >= ToBeFreezed)
                                    {
                                          // If someone bid before he gets his
                                          // money back
                                          if(Auction.Buyer)
                                          {
                                                  Auction.Buyer.Money +=
                                                        Auction.BuyerFreezedAmount;
                                          }
                                          Auction.Buyer = CurrentUser;
                                          Auction.CurrentPrice = Input.BuyPrice;
                                          Auction.Buyer.Money −= ToBeFreezed;
                                    }
                            }
                      }
                      // possibility to bid if you are not the highest bidder
                      if(Auction.Buyer != CurrentUser)
                      {
                            // BuyPrice of minimum StartPrice or higher than
                            // CurrentPrice when there was a bidder before
                            ShowNumberField(“BuyPrice”);
                            ShowButton(“Bid”);
                      }
              }
        }
        else if(Auction.Mode == “AuctionBuyerFound”)
        {
              if(WasButtonPressed(“BuyerCompletesMoneyFreezingProcess”))
              {
                      if(CurrentUser == Auction.Buyer)
                      {
                            // Freeze remaining money of bid price
                            Remaining = Auction.CurrentPrice −
                                    ((Auction.CurrentPrice/100.0)*BidPercentage);
                            if(Auction.Buyer.Money >= Remaining)
                            {
                                    Auction.Buyer.Money −= Remaining;
                                    Auction.State = “BuyerFrozeMoney”;
                            }
                      }
              }
              else if(WasButtonPressed(“SellerStatesShipping”))
              {
                      if(CurrentUser == Auction.Seller)
                      {
                            AutionState = “SellerStatedShipping”;
                      }
              }
              else if(WasButtonPressed(“BuyerConfirmsGoods”+
                      “TrueToDescription”))
              {
                      if(CurrentUser == Auction.Buyer)
                      {
                            // Give seller his frozen money back and also
                            // the buyers bid price
                            Auction.Seller.Money += Auction.SellerFrozen +
                            Auction.CurrentPrice;
                            Auction.State = “AuctionDone”;
                      }
              }
              else if(WasButtonPressed(“BuyerClaimsAnnulationBecauseOf”+
                      “GoodsDifferingFromDescriptionAndStatesShippingBack”))
              {
                      if(CurrentUser == Auction.Buyer)
                      {
                            Auction.State = “BuyerClaimedAnnulationBecauseOf”+
                            “GoodsDifferingFromDescriptionAndStatedShippingBack”;
                      }
              }
              else if(WasButtonPressed(“SellerConfirmsGoodsAreShippedBack”+
                      “AsTheyWereBeforeAndAcceptsAnnulation”))
              {
                      if(CurrentUser == Auction.Seller)
                      {
                            // Liquify each ones assets
                            Auction.Seller.Money += Auction.SellerFrozen;
                            Auction.Buyer.Money += Auction.CurrentPrice;
                            Auction.State = “AuctionDone”;
                      }
              }
              // Codes are not necessary, but if they are used we need
              // a way to pay them out
              // Paying out a pair of codes is also possible outside the
              // auction overview by iterating through the auctions
              // and check their codes (you could fix the paying out
              // process to just a few people but atleast the seller and
              // the buyer)
              else if((Input.Code1 == Auction.SellerCode &&
                      Input.Code2 == Auction.BuyerCode) ||
                      (Input.Code1 == Auction.BuyerCode &&
                      Input.Code2 == Auction.SellerCode))
              {
                      if(CurrentUser == Auction.Seller)
                      {
                            // Give seller his frozen money back and also
                            // the buyers bid price
                            Auction.Seller.Money += Auction.SellerFrozen +
                                    Auction.CurrentPrice;
                            Auction.State = “AuctionDone”;
                      }
                      else if(CurrentUser == Auction.Buyer)
                      {
                            // Liquify each ones assets
                            Auction.Seller.Money += Auction.SellerFrozen;
                            Auction.Buyer.Money += Auction.CurrentPrice;
                            Auction.State = “AuctionDone”;
                      }
              }
              if(Auction.State == “NothingDoneSoFar”)
              {
                      if(CurrentUser == Auction.Buyer)
                      {
                            ShowButton(“BuyerCompletesMoneyFreezingProcess”);
                      }
              }
              else if(Auction.State == “BuyerFrozeMoney”)
              {
                      if(CurrentUser == Auction.Seller)
                      {
                            ShowButton(“SellerStatesShipping”);
                      }
              }
              else if(Auction.State == “SellerStatedShipping”)
              {
                      if(CurrentUser == Auction.Buyer)
                      {
                            ShowButton(“BuyerConfirmsGoodsTrueToDescription”);
                            ShowButton(“BuyerClaimsAnnulationBecauseOfGoods”+
                                    “DifferingFromDescriptionAndStatesShippingBack”);
                      }
              }
              else if(Auction.State == “BuyerClaimedAnnulationBecauseOf”+
                      “GoodsDifferingFromDescriptionAndStatedShippingBack”)
              {
                      if(CurrentUser == Auction.Seller)
                      {
                            ShowButton(“SellerConfirmsGoodsAreShippedBack”+
                                    “AsTheyWereBeforeAndAcceptsAnnulation”);
                            ShowButton(“SellerConfirmsGoodsAreShippedBack”+
                                    “AsTheyWereBeforeButDoesNotAcceptAnnulation”);
                      }
              }
              // Display codes
              if(Auction.State != “AuctionDone”)
              {
                      if(CurrentUser == Auction.Seller)
                      {
                            ShowCode(Auction.SellerCode);
                      }
                      else if(CurrentUser == Auction.Buyer)
                      {
                            ShowCode(Auction.BuyerCode);
                      }
              }
        }
}
// Timeout handling
// Auction runs out of time
if(TimeStamp( ) > Auction.StartTime+(Auction.Days*60*60*24))
{
        if(!Auction.Buyer)
        {
              Auction.Seller.Money += Auction.SellerFrozen;
              AuctionMode = “AuctionDone”;
        }
        else
        {
              AuctionMode = “AuctionBuyerFound”;
        }
}
else if(SellerTimesOutOnCriticalAuctionMode)
{
        OnePercent = (Auction.StartPrice/100.0)*1.0;
        Remaining = Auction.SellerFrozen−OnePercent;
        Auction.Seller.Money += Remaining;
        Auction.Buyer.Money += Auction.CurrentPrice+OnePercent;
        Auction.Mode = “AuctionDone”;
}
else if(BuyerTimeOutOnCriticalAuctionMode)
{
        Auction.Seller.Money += Auction.SellerFrozen+
              ((Auction.CurrentPrice/100)*BidPercentage);
        Auction.Mode = “AuctionDone”;
}
```

We claim:

1. A system for fraud prevention and safe handling of payments for business to business, business to consumer and consumer to consumer or any similar cases, in which none of the contracting parties has at the same time control over money and goods or over money and services:
that is an instrument, in which the operator or operating company that supplies the service of the fraud prevention system to the contracting parties does not interfere or take position, the participating and contracting parties have active control during every decisional step of the transaction in full security;
that prevents the loss of money by freezing the sum related to the specific transaction contracted by the involved parties on the buyers account and a certain variable percentage of that sum as a deposit on the vendors account until the transaction is concluded when no matter who (vendor or buyer) enters both codes, the cash flow takes then place in the direction of the account of that party who entered both or respectively more codes and the deposit of the vendor is also unfreezed;
that is as preferred embodiment implemented on a computer or electronic terminal;
that can be used in the case of a computer or electronic terminal with input of components of a code that is generated random by the system, these components are sent to the different parties, every contracting party holds a different component of the code, or in alternative to the code system the contracting parties (two or more) can confirm or refuse by mouseclick or other methods like keyboard or any other or combinations of the described, usually in commerce there are two contracting parties (vendor and buyer);
that can also be used manually personally by appointing a fiduciary like for instance a notary or other third person who allows a payment for the conclusion of a transaction when he has the agreement of all the involved parties or the components of the code that are necessary to complete together the code, that is necessary to allow a payment;
that can also be used for reverse transactions in the case of complaint of the contracted goods or services, if they do not correspond to their description, in case of complaint the goods have to be sent back to the vendor, who has to confirm the receipt and decide whether he agrees to cancel the transaction or if he wants to refuse the reason of the complaint. In case of a refusal of a complaint the money remains frozen on the respective accounts. The two or more contracting parties have to come to an agreement with each other or go to law, in order to obtain a decision by the judge, which designates who will be in possession of the unfreezed money by getting the code or codes from the other party or parties or by confirmation towards a fiduciary or confirmation on a computer or electronic terminal or similar technology that is connected to the fraud prevention system;
in which the account used for the transaction can either be an e-wallet account or a bank account or other similar accounts;
in which the preferred embodiment is that all contracting parties have their account at the same e-wallet firm or a bank account at the same bank and that a trading platform is combined with that very bank or e-wallet firm; it is also possible that the contracting parties have accounts at different banks or at different e-wallet firms and the transfer of the money can occur between a bank account and an e-wallet account, between two bank accounts or between two e-wallet accounts or between any account where money or other securities like stocks, future warrants, commodities and other similar to them are deposited and that these could also be used as alternative payment methods, if the contracting parties agree;
that can be combined to any existing trading and auction internet platform or to peculiar swapping or reverse auction platforms or similar platforms;
that can also be used for quality management for instance in any manufacturing process or for any pay out process in tranches for instance in the property developer business as a construction progresses or other similar cases;
that can also be used for instant money transfer in a pay-out process by handing out two or respectively more components of a code that together form a code, by the input of all the components of the code, the cash flow takes then place in the direction of the account of the contracting party or person who entered both or respectively more codes, the money could even be payed out cash and even to a person who has no bank account or e-wallet or other similar account at all;
that can be used for any kind of commerce of goods or services described in the international Schedule of Classes of Goods as class 1. Chemicals used in industry, science and photography, as well as in agriculture, horticulture and forestry; unprocessed artificial resins; unprocessed plastics; manures; fire extinguishing compositions; and soldering preparations; chemical substances for preserving foodstuffs; tanning substances; adhesives used in industry, class 2. paints, varnishes, lacquers; preservatives against rust and against deterioration of wood; colorants; mordants; raw natural resins; metals in foil and powder form for painters, decorators, printers and artists, class 3. Bleaching preparations and other substances for laundry use; cleaning, polishing, scouring and abrasive preparations; soaps; perfumery, essential oils, cosmetics, hair lotions; dentifrices, class 4. industrial oils and greases; lubricants; dust absorbing, wetting and binding compositions; fuels (including motor spirit) and illuminants; candles and wicks for lighting, class 5. pharmaceutical and veterinary preparations; sanitary preparations for medical purposes; dietetic substances adapted for medical use, food for babies; plasters, materials for dressings; material for stopping teeth, dental wax; disinfectants; preparations for destroying vermin; fungicides, herbicides, class 6. metals and their alloys; metal building materials; transportable buildings of metal; materials of metal for railway tracks; nonelectric cables and wires of common metal; ironmongery, small items of metal hardware; pipes and tubes of metal; safes; goods of common metal not included in other classes; class 7. Machines and machine tools; motors and engines (except for land vehicles); machine coupling and transmission components (except for land vehicles); agricultural implements other than hand-operated; for eggs, class 8. hand tools and implements (hand-operated); cutlery; side arms; razors, class 9. Scientific, nautical, surveying, photographic, cinematographic, optical, weighing, measuring, signalling, checking (supervision), life-saving and teaching apparatus and instruments; apparatus and instruments for conducting, switching, transforming, accumulating, regulating or controlling electricity; apparatus for recording, transmission or reproduction of sound or images; magnetic data carriers, recording discs; automatic vending machines and mechanisms for coin operated apparatus; cash registers, calculating machines, data processing equipment and computers; fire extinguishing apparatus, class 10. surgical, medical, dental, and veterinary apparatus and instruments, artificial limbs, eyes, and teeth; orthopedic articles; suture materials, class 11. Apparatus for lighting, heating, steam generating, cooking, refrigerating, drying, ventilating, water supply, and sanitary purposes, class 12. vehicles; apparatus for locomotion by land, air, or water, class 13. firearms; ammunition and projectiles; explosives; fireworks, class 14. precious metals and their alloys and goods in precious metals or coated therewith, not included in other classes; jewelry, precious stones; horological and chronometric instruments, class 15. musical instruments, class 16. paper, cardboard and goods made from these materials, not included in other classes; printed matter; bookbinding material; photographs; stationery; adhesives for stationery or household purposes; artists' materials; paint brushes; typewriters and office requisites (except furniture); instructional and teaching material (except apparatus); plastic materials for packaging (not included in other classes); printers' type; printing blocks, class 17. rubber, gutta-percha, gum, asbestos, mica and goods made from these materials and not included in other classes; plastics in extruded form for use in manufacture; packing, stopping and insulating materials; flexible pipes, not of metal, class 18. leather and imitations of leather, and goods made of these materials and not included in other classes; animal skins, hides; trunks and travelling bags; umbrellas, parasols and walking sticks; whips, harness and saddlery, class 19. building materials (non-metallic); nonmetallic rigid pipes for building; asphalt, pitch and bitumen; nonmetallic transportable buildings; monuments, not of metal, class 20. furniture, mirrors, picture frames; goods (not included in other classes) of wood, cork, reed, cane, wicker, horn, bone, ivory, whalebone, shell, amber, mother-of-pearl, meerschaum and substitutes for all these materials, or of plastics, class 21. household or kitchen utensils and containers; combs and sponges; brushes (except paint brushes); brush-making materials; articles for cleaning purposes; steel-wool; unworked or semi-worked glass (except glass used in building); glassware, porcelain and earthenware not included in other classes, class 22. ropes, string, nets, tents, awnings, tarpaulins, sails, sacks and bags (not included in other classes); padding and stuffing materials (except of rubber or plastics); raw fibrous textile materials, class 23. Yarns and threads, for textile use, class 24.textiles and textile goods, not included in other classes; beds and table covers, class 25. clothing, footwear, headgear, class 26. lace and embroidery, ribbons and braid; buttons, hooks and eyes, pins and needles; artificial flowers, class 27. carpets, rugs, mats and matting, linoleum and other materials for covering existing floors; wall hangings (non-textile), class 28. games and playthings; gymnastic and sporting articles not included in other classes; decorations for Christmas trees, class 29. meat, fish, poultry and game; meat extracts; preserved, frozen, dried and cooked fruits and vegetables; jellies, jams, compotes; eggs, milk and milk products; edible oils and fats, class 30. coffee, tea, cocoa, sugar, rice, tapioca, sago, artificial coffee; flour and preparations made from cereals, bread, pastry and confectionery, ices; honey, treacle; yeast, baking powder; salt, mustard; vinegar, sauces (condiments); spices; ice, class 31. agricultural, horticultural and forestry products and grains not included in other classes; live animals; fresh fruits and vegetables; seeds, natural plants and flowers; foodstuffs for animals; malt, class 32. beers; mineral and aerated waters and other nonalcoholic drinks; fruit drinks and fruit juices; syrups and other preparations for making beverages, class 33. alcoholic beverages (except beers), class 34. tobacco; smokers' articles; matches and services, class 35. advertising; business management; business administration; office functions, class 36. insurance; financial affairs; monetary affairs; real estate affairs, class 37. building construction; repair; installation services, class 38. telecommunications, class 39. transport; packaging and storage of goods; travel arrangement, class 40. treatment of materials, class 41. education; providing of training; entertainment; sporting and cultural activities, class 42. scientific and technological services and research and design relating thereto; industrial analysis and research services; design and development of computer hardware and software, class 43. Services for providing food and drink; temporary accommodations, class 44. medical services; veterinary services; hygienic and beauty care for human beings or animals; agriculture, horticulture and forestry services, class 45. legal services; security services for the protection of property and individuals; personal and social services rendered by others to meet the needs of individuals or similar goods or services.
